(19) United States
(12) Patent Application Publication
(10) Pub. No.: US 2010/0001536 A1
(43) Pub. Date: Jan. 7, 2010

(54) METHOD AND APPARATUS FOR GENERATING MOTION OF A SERIES OF HOLLOW ELEMENTS IN A FLUID ENVIRONMENT

(76) Inventors: Paolo Pace, Casavatore (IT); Michele Preziuso, Nonantola (IT); Lorenzo Verdoscia, Napoli (IT)

Correspondence Address: YOUNG & THOMPSON, 209 Madison Street, Suite 500, Alexandria, VA, 22314, US

(21) Appl. No.: 12/447,120

(22) PCT Filed: Oct. 23, 2007
(86) PCT No.: PCT/IT2007/000738

§ 371 Date: Apr. 24, 2009

(30) Foreign Application Priority Data
Oct. 24, 2006 (IT) NA2006A000127

(51) Int. Cl. F02B 63/04; F03B 17/04

(52) U.S. Cl. 290/1 R; 74/DIG. 9

(57) ABSTRACT

A method of generating motion in a second fluid (f2) of a series of hollow elements (12) which are bound to each other in sequence and fillable with a first fluid (f1) lower in density than the second fluid (f2), the two fluids being immiscible, includes the steps of arranging hollow elements (12) to move along an endless guide (9) vertically extending inside a container (1); providing two chambers (C1, C2) positioned at different heights in the container (1), both chambers containing the first fluid (f1) and having an opening downwards which the hollow elements (12) enter and exit; filling the container (1) with the second fluid (f2); causing each of the hollow elements (12) first to open and then close in chambers (C1, C2) establishing a transmission of motion of the series of hollow elements (12) to a power take-off outside the container (1). An apparatus is also described.

### TECHNICAL FIELD

The present invention relates to a method of generating motion of a series of hollow elements in a fluid environment, and an apparatus therefor.

In particular, the method according to the present invention uses gravitational energy that in the form of potential energy is transformed into kinetic energy when a body immersed in a fluid environment is in free fall. The method is useful to obtain green energy, particularly where other energy sources are lacking or insufficient and cannot ensure continuous, immediate, and low cost energy. Hence, it is appropriate for providing, for every day needs, individuals and communities with clean, renewable and easily transformable energy, with low cost and lowest environmental impact, by means of non-polluting fluids that are abundant in nature and are a valid alternative to energetic sources that are non-renewable and/or produce polluting and noxious substances or wastes into the environment.

### BACKGROUND ART

As known, there are various methods that use fluids to convert potential gravitational energy into kinetic energy to produce work.

A first method, for example, is used in hydroelectric plants and utilises fluids in motion to produce electric energy.

However, this method presents various drawbacks: the environmental impact when water is deviated or collected artificially; the fact that when water is transformed into potential energy>kinetic energy>mechanical energy>electric energy, it cannot be employed again by the same hydroelectric plant for the production of electricity unless one renounces to the benefits of the transformation sending the water back up for recycling; the fact that our planet does not host many suitable sites for this type of transformation.

Another method is based on the thrust of Archimedes and requires a fluid at rest and a body, totally o partially immersed in it, whose densities are respectively ρ_{flu} and ρ_{cor} so that we can have:

1. If ρ_{flu}<ρ_{cor}, the body tends to fall.

2. If ρ_{flu}>ρ_{cor}, the body tends to rise.

In the state of the art there is an Italian patent N. 1253619 that describes a device that exploits the thrust of Archimedes. It is based on the capturing of gas, in particular air, in special sacs put inside a liquid, in particular water, in contact with the atmosphere.

The solution proposed presents various drawbacks. A first great drawback regards the use of an external power source to fill the sacs with gas. In fact, on account of gas compressibility, in order to put the gas into the liquid without having the liquid escape from the same way, the gas pressure must be higher than the liquid pressure at the gas injection point increased by the atmospheric pressure, since the liquid is in contact with the atmosphere.

A second drawback regards the fact that the liquid must be kept in contact with the atmosphere to allow the gas to escape when the sacs reach their top level, avoiding thus a continuous increase of both liquid and injected gas pressure and external energy to make the system work.

Another drawback lays in the fact that the sacs must move only in a liquid and not, more generally, in a fluid.

As demonstrated, the method described in the above mentioned Italian patent must necessarily use an external energy source that compresses the gas to reach the injection pressure in order to supply the sacs with pressurised gas to make the system work.

Hence, if a continuous energy supply for the gas compression is not available, the system cannot work.

Further, even if a continuous external source is available, the approach proposed does not account for the overall yield of the system (motor mechanisms, liquid characteristics, etc.) expressed in terms of the relationship: available energy/consumed energy, the latter including the amount of external energy supplied to the system.

Another negative aspect is that the pressurised gas is lost in the atmosphere after its use and is therefore no longer useful.

Even if the two methods described above differ in their characteristics (the first one with water in motion, the second one with water atrest), they are both similar because the system used to transform potential energy into kinetic energy cannot reutilize the same fluid (respectively water and air) for another transformation, unless they lose all of the energy produced.

This invention aims at solving the problems of the preceding techniques, providing a method that allows the reutilization of the fluid losing only part of the energy produced.

The method according to the invention takes advantage of the following principle: in a receptacle containing fluid at rest, for example in contact with the atmosphere, a body completely immersed in the fluid will reach a floating level if its average density is less than that of the fluid and is greater than that of the air, and the friction can be neglected. If instead its average density is greater than that of the fluid, the body will reach the bottom of the receptacle.

The aim of the invention is to provide a method for green and renewable energy transformation in order to obtain work from bodies immersed in fluids by converting potential gravitational energy into kinetic energy overcoming the drawbacks of the prior art.

Furthermore, a specific aim of this invention is to provide an apparatus to carry out the method of the invention.

### DISCLOSURE OF INVENTION

Hence, in a first aspect, the invention provides a method of generating motion of a series of hollow elements in a fluid environment which are bound to each other in sequence and are fillable with a first fluid that is lower in density than a second fluid constituting the fluid environment where the series of hollow elements are caused to move, the first fluid and the second fluid being immiscible with each other, the method comprising the steps of:
arranging a series of hollow elements to move along an endless guide vertically extending inside a container;
providing at least two chambers positioned at different heights in the container so that one chamber is lower than the other upper chamber, both chambers containing the first fluid and having an opening downwards which said hollow elements in sequence on the endless guide are constrained to enter and exit; filling the container with the second fluid;
causing each of the hollow elements of the series of hollow elements first to open and then close when it passes through each of said chambers; and
establishing a transmission of the motion of said series of hollow elements to a power take-off outside the container.

In a second aspect, the invention provides an apparatus for moving in a fluid environment a series of hollow elements which are bound to each other in sequence and are fillable with a first fluid that is lower in density than a second fluid constituting the fluid environment where they are caused to move, the first fluid and the second fluid being immiscible with each other, the apparatus comprising:

a container containing the second fluid as well as a vertically extending, endless guide for a series of hollow elements;

at least two chambers inside the container being provided with an opening facing downwards through which said endless guide passes in order to allow the series of hollow elements along the endless guide to enter and exit each of the two chambers, one chamber being lower than the other upper chamber and both chambers being at least partially filled

a series of hollow elements in the form of elements being suitable to be opened and closed, said hollow elements being equipped with sliding means to slide along said guide;

an opening/closing station to open and close said hollow elements in each of said chambers;

driving means being connected to said hollow elements; motion transmission means for transmitting motion from said driving

### BRIEF DESCRIPTION OF DRAWINGS

The invention will be now described in an illustrative and not limiting way with reference to the figures in the accompanying drawings, wherein

FIG. 1 is a flow chart of a method according to an embodiment of the invention;

FIG. 2 shows a cross section of an apparatus according to an embodiment of the invention; and

FIG. 3 shows a view of the apparatus along the lines I-I in FIG. 2.

### BEST MODE FOR CARRYING OUT THE INVENTION

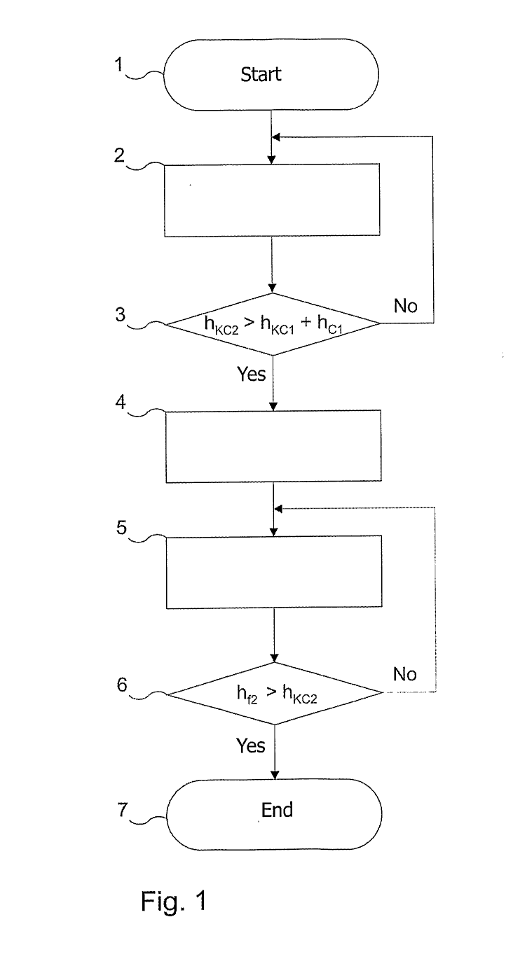

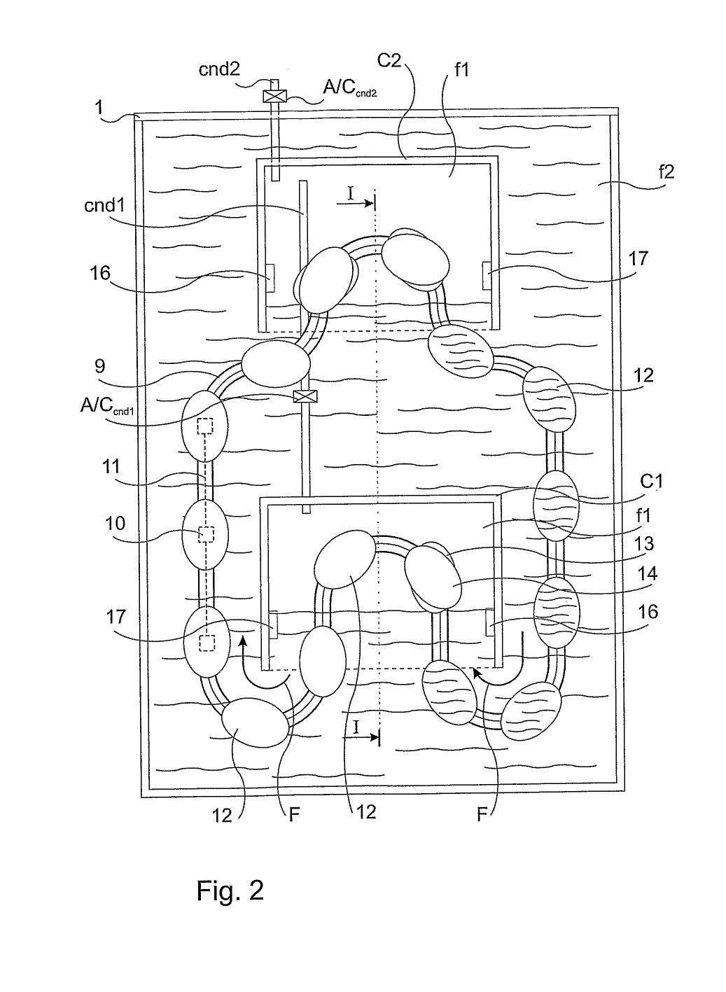

With reference to FIGS. 1 and 2, which are a flow chart of part of the method according to the invention, and a cross section of an embodiment of the apparatus adapted to carry out the method, respectively, the method uses two immiscible fluids having a different average density, at rest, to automatically change the average density of bodies immersed inside said fluids. The method comprises the steps of: disposing of at least two immiscible fluids f1 e f2 with different densities respectively named ρ_{f1} e ρ_{f2}. In container 1, having a height h_{K} and being large enough to contain fluids f1 e f2, two chambers are set up: a first chamber C1 with height h_{C1} and then a second chamber C2 with height h_{C2}.

Chambers C1 e C2 are situated respectively at heights h_{KC1} e h_{KC2} from the bottom of container 1.

The chambers are connected by a pipe cndl equipped with a controlled opening/closing device A/C_{cnd1}.

Another pipe cnd2 provided with a controlled opening/closing device A/C_{cnd2} is attached to chamber C2.

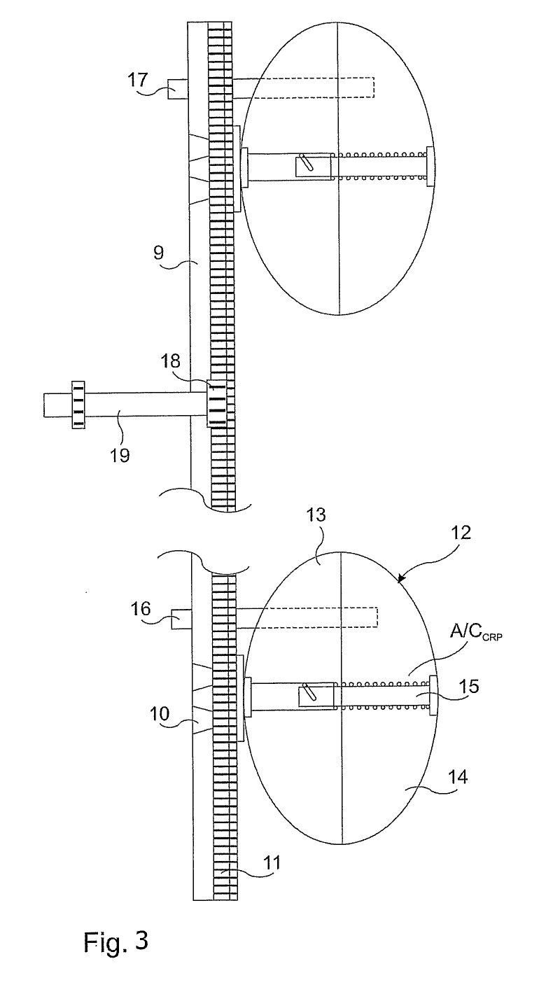

A series of hollow, impermeable elements 12 are put in container 1. The average density ρ_{CRP} of the elements is higher compared to that of the fluids; their external volume is Ve_{CRP} and the volume of the cavity ViCRP less than Ve_{CRP}; the container is equipped with a controlled opening/closing system A/C_{CRP} so that, when necessary, the hollow elements 12 can enclose fluid f1 or fluid f2 in their cavity together with the pre-enclosed lower density fluid. The opening/closing system A/C_{CRP} can be observed in FIG. 3, that is a view according to line I-I in FIG. 2.

Container 1 is filled first with lower density fluid f1, for example with air, and then with higher density fluid f2, for example with water, so that the lower density fluid can be trapped in chambers C1 and C2 by the higher density fluid.

The fluid pressure enclosed in chamber C2 is brought to the same pressure of the fluid trapped in chamber C1.

The motion of each hollow element 12 is oriented so that, due to the force produced by the potential gravitational energy, each element may move alternately from chamber C2 to chamber C1 according to the arrows F in FIG. 2.

According to the invention two immiscible fluids f1 e f2 whose respective densities ρ_{f1} e ρ_{f2} are in the relationship ρ_{f1}<ρ_{f2} can be chosen.

According to the invention, the height of chamber C1 can be h_{C1}<h_{K}.

Chamber C1 can be open on the bottom with the opening facing downwards towards the bottom of container 1.

Chamber C1 can be placed at a certain height from the bottom of container 1 so that: h_{C1}+h_{KC1}<h_{K}.

Chamber C2 can be placed at height h_{C2}<h_{K}.

Chamber C2 can be open on the bottom with the opening facing downwards towards the bottom of container 1.

Chamber C2 can be placed so that the height results to be h_{C1}+h_{KC1}<h_{KC2}<h_{C2}+h_{KC2} and h_{K}>h_{KC2} from the bottom of container 1.

According to the invention it may be ρ_{CRP}≧ρ_{f2}. The average density of the hollow element 12 when it encloses fluid f1 can be less than the density of fluid f2.

Inside chamber C1 the pressure of fluid f1 can be that of fluid f2.

Inside chamber C2 the pressure of fluid f1 can be that of the fluid itself inside chamber C1.

By changing height h_{KC2} the kinetic energy that can be transformed in work can vary.

Preferably, according to the invention ρ_{f2} should be at least two order of magnitude greater than ρ_{f1}.

Advantageously, ρ_{f2} is approximately three order of magnitude greater than ρ_{f1}.

Advantageously, fluid f1 is air.

Advantageously, fluid f2 is water.

The same pressure value in fluid f1 in chamber C2 is obtained by pressurised external fluid f1.

The volume Vi_{CRP} is close to volume Ve_{CRP}.

Advantageously according to the invention, the hollow element 12 has an ellipsoid shape, more advantageously of a prolate spheroid.

With reference to FIG. 1, the method of the invention allows the transformation of potential gravitational energy into kinetic energy, hence into mechanical energy using fluids at rest and a series of hollow elements free to move in the fluids.

In step 1 all the necessary elements must be available, such as the container and the two fluids, that must be immiscible and of different density.

In step 2 the two chambers are set up in the container at different heights. For simplicity the lower chamber is named C1 while the higher one is named C2. These chambers allow the variation of the average density of each hollow element. Then, in step 3 the minimum levels of chambers C1 e C2 from the bottom are checked and subsequently, in step 4, the container is filled with the lower density fluid named f1. In step 5 the container is filled with the higher density fluid named f2, and in step 6 its minimum level is checked to be sure that f1 is completely trapped in C2. In step 7, potential gravitational energy is converted into kinetic energy using an impermeable body as a hollow element, whose average density is greater or equal to f2 density and in which f1 was previously enclosed. Having enclosed f1 the body tends to rise, hence, letting it pass through C2, it releases f1 and starts to fall due to gravity. Passing through C1, it once again encloses f1 and due to the thrust of Archimedes it tends to rise, and so on.

Another advantage of the method according to the present invention to be pointed out is the possibility to transform gravitational energy into mechanical energy and, at the same time, create self sufficient energy provided by the fluids in motion, although using fluids at rest.

FIG. 2 is a schematic representation of an apparatus to carry out the method of the invention.

The apparatus mainly consists of a container 1, as from step 1 in FIG. 1, and an endless structure 9 featuring at least one guide where roller shoes 10, i.e. sliding shoes, slide. The roller shoes 10, which are made of a water resistant material, are connected to each other suitably spacedly by means of a flexible transmission in the form of a toothed belt 11, in order to transmit the motion produced, e.g., to a generator that produces electric energy.

The prolate spheroid-shaped hollow elements 12 made of light-weight material are then attached, one by one, to each sliding roller shoe 10.

The hollow elements 12 consist of two shells, of which a shell 13 is attached to the sliding shoe, and the other shell 14 is movable with respect to the first shell 13, but is bound thereto, and may rotate and/or slide, thanks to a mechanical system, allowing the spheroid to be opened, the two shells to move apart and then the spheroid to be closed. In FIG. 2, the hollow elements 12 are shown moving down, on the right, full of water, and moving up, on the left, full of air.

Referring to FIG. 3, that is a view of the apparatus along the arrows I-I in FIG. 2, there are shown the hollow elements in ghost, as already described with reference to FIG. 2.

In FIG. 3 there is shown diagrammatically a telescopic spring mechanism 15 for lifting shell 14 above shell 13 in each hollow element 12 when it opens and then lowers it when it closes. These phases are controlled in the opening and closing stations, respectively 16 and 17 of each chamber C1 and C2, by means of a control cam (indicated with the same number of the related station) that interacts with the hollow element.

In FIG. 3 there is also shown the flexible toothed belt 11, that follows the pattern for the guide 9 for the hollow elements 12. The belt 11 is rigidly connected to the sliding shoes 10 that support the hollow elements 12 and allow them to slide on the guide 9. A pinion, as diagrammatically shown and indicated at 18, is keyed to an end of a driven shaft 19 connected to a power take-off outside the container.

The method of the present invention may be used in all industrial and technological fields where directly usable or further transformable mechanical energy is needed.

The invention has been described in an illustrative and non limiting way according to preferred embodiments, but it is evident that for the skilled in the art additions and/or modifications are possible without departing from the scope of the invention as specified in the enclosed claims.

1. Method of generating motion of a series of hollow elements in a fluid environment which are bound to each other in sequence and are fillable with a first fluid that is lower in density than a second fluid constituting the fluid environment where the series of hollow elements are caused to move, the first fluid and the second fluid being immiscible with each other, characterised in that the method comprises the steps of:
arranging a series of hollow elements to move along an endless guide vertically extending inside a container;
providing at least two chambers positioned at different heights in the container so that one chamber is lower than the other upper chamber, both chambers containing the first fluid and having an opening downwards which said hollow elements in sequence on the endless guide are constrained to enter and exit;
filling the container with the second fluid;
causing each of the hollow elements of the series of hollow elements first to open and then close when it passes through each of said chambers; and
establishing a transmission of the motion of said series of hollow elements to a power take-off outside the container.

2. Method according to claim 1, characterised in that the inside of said container communicates with the atmosphere.

3. Method according to claim 1, characterised in that the inside of said container does not communicate with the atmosphere.

4. Method according to claim 1, characterised in that the two chambers are communicating with each other.

5. Method according to claim 1, further comprising a step of adjusting the fluid in the lower chamber in its pressure value with respect to that in the upper chamber.

6. Method according to claim 1, characterised in that the pressure of the fluid in said upper chamber is adjustable.

7. Method according to claim 1, characterised in that the first fluid being of lower density is air, and the second fluid constituting the fluid environment is water.

8. Apparatus for moving a series of hollow elements in a fluid environment which are bound to each other in sequence and are fillable with a first fluid that is lower in density than a second fluid constituting the fluid environment where they are caused to move, the first fluid and the second fluid being immiscible with each other, characterised in that the apparatus comprises:
a container containing the second fluid as well as a vertically extending, endless guide for a series of hollow elements;
at least two chambers inside the container being provided with an opening facing downwards which said endless guide passes in order to allow the series of hollow elements along the endless guide to enter and exit each of the two chambers, one chamber being lower than the other upper chamber and both chambers being at least partially filled with the first fluid;
a series of hollow elements in the form of elements being suitable to be opened and closed, said hollow elements being equipped with sliding means to slide along said guide;
an opening/closing station to open and close said hollow elements in each of said chambers;
driving means being connected to said hollow elements; motion transmission means for transmitting motion from said driving means to a power take-off outside said container.

9. Apparatus according to claim 8, characterised in that the inside of said container communicates with the atmosphere.

10. Apparatus according to claim 8, characterised in that the inside of said container does not communicate with the atmosphere.

11. Apparatus according to claim 8, characterised in that said chambers communicate with each other by means of a connecting pipe.

12. Apparatus according to claim 11, characterised in that the connecting pipe is equipped with pressure adjusting means for adjusting the pressure value in the lower chamber with respect to that one in the upper chamber.

13. Apparatus according to claim 12, characterised in that the upper chamber is connected to a source of pressurised, low density fluid.

14. Apparatus according to claim 8, characterised in that each of said hollow elements comprises two diametrically matching, ellipsoid-shaped shells which are able to rotate with respect to each other.

15. Apparatus according to claim 14, characterised in that said shells are mutually connected by a spring loaded, telescopic element which allows one shell to rotate with respect to the other.

16. Apparatus according to claim 8, characterised in that each of said hollow elements comprises two diametrically matching, ellipsoid-shaped shells which are able to shift with respect to each other.

17. Apparatus according to claim 8, characterised in that each of said hollow elements is equipped with sliding roller shoes.

18. Apparatus according to claim 8, characterised in that the driving means further comprises a flexible transmission which the hollow elements are connected to and that is free to move along side the guide.

19. Apparatus according to claim 8, characterised in that said motion transmission means comprises at least a pinion which meshes said flexible transmission and is integral with a driven shaft as a power take-off.

20. Apparatus according to claim 8, characterised in that said opening/closing station of the hollow elements correspondingly to each of said chambers comprises cams for the mutual rotation or shifting of each shell with respect to the other in each hollow element.
